(19) United States
(12) Patent Application Publication
(10) Pub. No.: US 2003/0085586 A1
(43) Pub. Date: May 8, 2003

(54) Sectional removably attachable top

(76) Inventors: Pete Nick Kiousis, Birmingham, MI (US); James Thomas Burkel, Chelsea, MI (US)

Correspondence Address: Pete Nick Kiousis, 1594 Sheffield, Birmingham, MI, 48009, US

(21) Appl. No.: 10/144,637

(22) Filed: May 13, 2002

Related U.S. Application Data
(63) Continuation-in-part of application No. 10/045,460, filed on Nov. 7, 2001.

(51) Int. Cl. B62D 25/06

(52) U.S. Cl. 296/102; 296/103

(57) ABSTRACT

A removably attachable top for vehicles. In a preferred embodiment, the top is composed of six panels: one front top panel, one rear top panel, one rear side panel, one front side panel, one right side panel, and one left side panel. When fully assembled, the top creates a rigid, weather-tight cover enclosing an open compartment of a vehicle. The individual panels of the top are easily removably attachable to each other and to the vehicle. The panels are also easily manageable during assembly and disassembly and storable, allowing the top to be selectively removed.

### CROSS-REFERENCE TO RELATED APPLICATIONS

This application is a continuation in part of U.S. application Ser. No. 10/045460 filed Nov. 7, 2001.

### BACKGROUND OF THE INVENTION

1. Field of the Invention

The present invention relates to a removably attachable top for a vehicle having an open compartment.

2. Background Art

Currently, removably attachable tops for vehicles such as pick up trucks and coupes, fixed, drop-head, or convertible (hereinafter referred collectively as “coupes”) are usually one-piece of rigid material such as fiberglass, aluminum, steel, or any other rigid material. The major drawback of the hard top is its awkward, cumbersome, and heavy design. It is virtually impossible for one person to remove the hard top unassisted, and removal usually requires the use of currently available mechanical devices, such as winches or hoists. Once removed, the one-piece hard top requires a large amount of space for storage, in part because it is fragile when removed and standing apart from the vehicle and must therefore be stored carefully. The one-piece top cannot be removed during a trip because there is no room to store the top.

Some flat bed trucks use simple walls made out of wood planks to secure the back of the flat bed truck. Tarps are then draped over the top to provide some protection from the environment. A drawback with this design is that it does not provide suitable protection or insulation from the elements and other environmental conditions.

It would be desirable to provide a removably attachable, rigid top for vehicles that reduces wind noise, provides better insulation, and is removable/attachable by one person.

### SUMMARY OF THE INVENTION

The objective of the invention is to provide a removably attachable, rigid top for vehicles that is composed of multiple, integrated panels that are easily attachable, manageable, removable, and storable by one person.

Another object of the invention is to produce a removable top that reduces wind noise and provides better insulation against the elements and other environmental conditions.

The removably attachable top of the present invention comprises a plurality of separate, removably attachable panels, each of which has four principal edges. The first embodiment of the present invention preferably comprises six separate pieces though it could be designed having fewer or more separate panels. When properly assembled, the panels form a rigid, removably attachable top that covers an open compartment. Once assembled, the top may be removed completely either in one piece (fully assembled) or, more preferably, panel by panel.

As mentioned, the top described herein is composed of multiple, integrated panels, making assembly and disassembly logical and easy. The first panel is a side panel. The second panel is a second side panel opposite the first side panel. Each side panel has top, bottom, front, and rear edges. The bottom edges of the first and second side panels of the invention are removably attachable to the corresponding first and second side structural portions of the vehicle.

The third panel of the invention is a rear side panel. The rear side panel of the invention has top, bottom, and two side edges. The bottom edge of the rear side panel of the invention is removably attachable to the rear structural portion of the vehicle. The side edges of the rear side panel of the invention are removably attachable to the corresponding adjacent rear side edges of the two opposite side panels of the invention.

The fourth panel of the invention is the front side panel. The front side panel of the invention has top, bottom, and two side edges. The bottom edge of the front side panel is removably attachable to the front structural portion of the vehicle. The side edges of the front side panel of the invention are removably attachable to the corresponding adjacent front side edges of the two opposite side panels of the invention.

The fifth panel of the invention is a front top panel. The front top panel of the invention has front, rear, and two side edges. The front edge of the front top panel is removably attachable to the top edge of the front side panel. In addition, sections of the side edges of the front top panel of the invention may also be removably attachable to sections of the corresponding adjacent top edges of the two opposite side panels of the invention.

The sixth panel of the invention is a rear top panel. The rear top panel of the invention has front, rear, and two side edges. The rear edge of the rear top panel of the invention is removably attachable to the adjacent top edge of the rear side panel of the invention. The side edges of the rear top panel of the invention are removably attachable to the corresponding adjacent top edges of the two opposite side panels of the invention. The front edge of the rear top panel of the invention is removably attachable to the adjacent rear edge of the front top panel of the invention. When assembled properly, the two top panels form a weather-tight barrier for pick up truck bed.

In addition to the four edges described above, the five panels may, as design requires, also have any of the following: flanges, catches for clamps, clamp assemblies, holes, integrated screws, nuts, and/or washers, projections, cooperating or non-cooperating steps, flat portions, flaps, windows, corrugations, dovetails, bores, and grooves. As technology permits or design requires, the panels may also have additional characteristics. Further, the side panels may also have hinged portions, allowing access to the interior of the cargo compartment of the vehicle.

A second embodiment of the invention comprises five separate removably attachable panels wherein the top is a single panel.

Further, the side panels may comprise multiple panels to facilitate assembly and disassembly by one person. In another embodiment, the side panels comprise forward and rearward panels for a total of six, seven or eight panels.

On another embodiment designed for smaller open compartments, such as the passenger compartment of a coupe, the removable top preferably comprises three panels—two side panels and a top panel. Or, it may comprise a two piece top panel—a top and a rear panel.

When fully assembled, the panels of the five panel, six panel, or other multiple panel removable tops of the present invention form a rigid, weather-tight, and removably attachable top for a vehicle.

The removably attachable top described herein offers the protection, security, and sound insulation comparable to currently available removably attachable hard tops, but is designed to be assembled, disassembled, and stored much more easily than either currently available removably attachable hard tops, allowing the driver or passenger(s) to remove the top before or during a trip. The combination of the strengths of the multi-panel, removably attachable top described herein with the ease of removal and storage made possible by its design makes the invention a desirable top for vehicles, allowing the driver or passenger(s) the freedom to remove and store the top at almost any point during a journey with little time or difficulty.

### BRIEF DESCRIPTION OF THE DRAWINGS

FIG. 1 is a perspective view of the removable top of the present invention on a vehicle;

FIG. 2a is a sectional view showing one method of attaching a side panel to the vehicle;

FIG. 2b is a sectional view showing a second method of attaching a side panel to the vehicle;

FIG. 2c is a sectional view showing a third method of attaching a side panel to the vehicle;

FIG. 2d is a sectional view showing a fourth method of attaching a side panel to the vehicle;

FIG. 3 is a sectional view showing one method of attaching a rear panel to the vehicle;

FIG. 4a is a perspective view showing the rear side panel connected to the side panel;

FIG. 4b is an exploded view of the attachment of FIG. 4a;

FIG. 4c is an exploded view of two other methods of attaching the rear panel to the side panel;

FIG. 4d is a sectional view of another method of attaching the side panel to the rear panel;

FIG. 5a is a sectional view showing one method of attaching the top panel to the side panel;

FIG. 5b is a sectional view showing a second method of attaching the top panel to the side panel;

FIG. 5c is a sectional view showing a third method of attaching the top panel to the side panel;

FIG. 5d is a sectional view showing a fourth method of attaching the top panel to the side panel;

FIG. 6a is a sectional view showing a method of attaching the top panel to the rear panel;

FIG. 6b is a sectional view showing a second method of attaching the panel to the rear panel;

FIG. 7a is a sectional view showing one method of attaching the top front panel to the vehicle and to the top rear panel;

FIG. 7b is sectional view showing a second method of attaching the top front panel to the top rear panel;

FIG. 8 is a side sectional view of a second embodiment of the present invention;

FIG. 9 is an exploded view of the removable top of the present invention;

FIG. 10 is a side sectional view of another embodiment of the removable top of the present invention;

FIG. 11 is an exploded view of another embodiment of the removable top of the present invention;

FIG. 12 is a perspective view of another embodiment of the removable top of the present invention on a vehicle;

FIG. 13 is a perspective view of yet another embodiment of the removable top of the present invention and a vehicle;

FIG. 13a is a sectional view of yet another embodiment of the removable top of the present invention;

FIG. 14 is a side view of yet another embodiment of the removable top of the present invention on a vehicle; and

FIG. 15 is an exploded view of yet another embodiment of the removable top of the present invention.

### DETAILED DESCRIPTION OF THE PREFERRED EMBODIMENT(S)

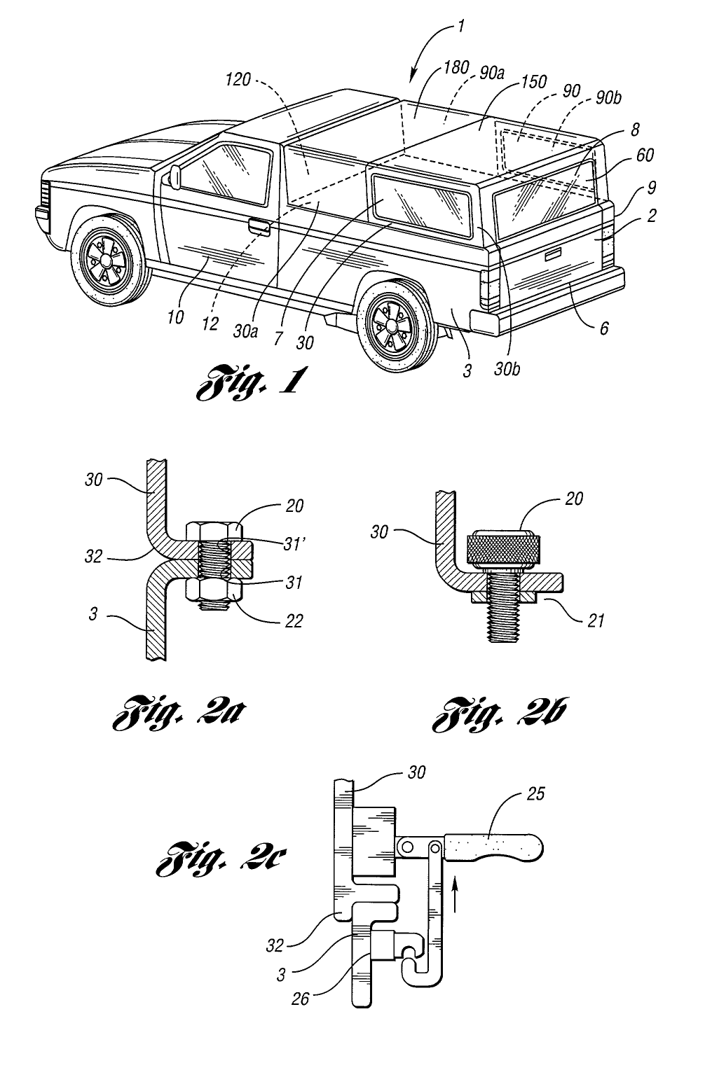

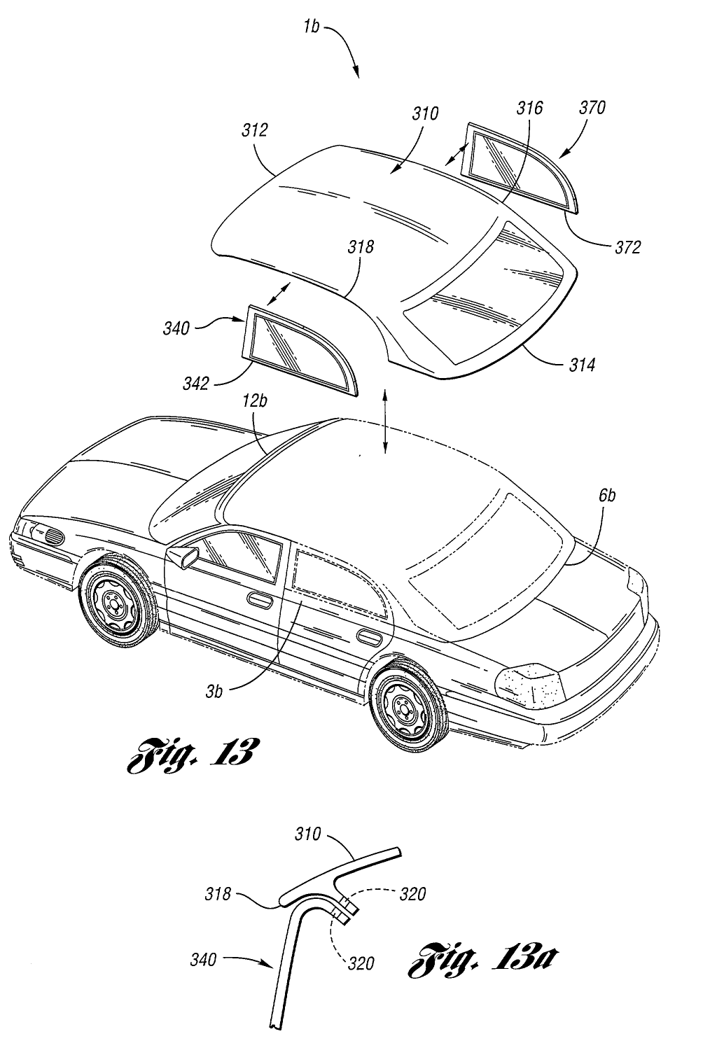

Referring now to FIG. 1, the removable top 1 of the present invention is shown fully assembled on top of a pick up truck or similar type vehicle 10 to cover the open compartment of a truck bed. The invention can also be modified to accommodate sport utility vehicles (SUV's), convertibles, and drophead-type coupes. FIG. 9 illustrates the removable top 1 of the present invention in an exploded view. FIGS. 10-15 illustrate another embodiments of the present invention.

Vehicle 10 has first side structural vehicle portion 3, second side structural vehicle portion 9, at least one rear side structural vehicle portion 6, and front structural vehicle member 12 which is generally the front wall of the truck bed. The rear side structural portion 6 may be a single portion, or, as is more frequently the case, comprise multiple subportions, two subportions formed when each of the side structural vehicle portions wrap at least partially around to the rear of the vehicle. The scope of the invention is not affected by having one or more rear portions. For simplification, the disclosure will merely refer to one rear side structural portion. The structural portions are generally the top of the truck bed side walls for a pick up truck. However, for other vehicles such as flat bed trucks, the structural portions may be truck bed frame or the floor itself.

The preferred embodiment of the removable top comprises six separate removably attachable panels—a first side panel 30, a rear side panel 60, a second side panel 90, a front side panel 120, a rearward top panel 150, and a forward top panel 180. For simplification, this disclosure commonly refers to just one side panel attachment, but the invention often requires a similar attachment for the other side panel. Alternate embodiments of the removable top 1 containing five, seven, eight or different number of panels are discussed below.

Preferably, the panels will be molded using fiberglass or injection molded out of a polymer such as ABS (acrylonitrile-butadiene-styrene), TPO (thermoplastic olefin), or TPU (thermoplastic urethane). The panels may also be made out of other composite materials, a metal, or other materials. The manufacturing of the panels will depend on the material. The panels 30, 60, 90, and 120 may have windows 7 as shown in FIG. 1 to allow the vehicle occupants to see outside of the vehicle. The windows 7 may be made out of glass, clear plastic, or other materials. Further, the windows 7 may be manufactured concurrently with the panels or may be added to the panels later. A liftgate or door structure 8 may also be included on the rear panel 60. The windows 7 or liftgate 8 may contain windshield wiper blades and a rear defroster/defogger. Top panels 150 and 180 may also have windows, moonroofs, or sunroofs (not shown). Preferably, the panels are substantially solid, as shown, and therefor form a substantially weather tight top when fully assembled. The panels may also be made in a nonsolid manner and allow greater airflow into the compartment.

The present invention could be used to provide secure storage over the open compartment of the vehicle. The side panels may come in different heights for different purposes. For example, the side panels may short to provide a sleek look and match the height of the cab or be taller to permit a person to stand upright in a camper-like top. The panels may also be insulated to provide protection from the environments in cases where people or pets may be contained within.

In most pick up trucks, the rear side structural portion 6 frequently includes a removable tailgate 2. Certain embodiments of the removable top 1 for camper-like top may have a rear side panel 60 that extends below the top of the truck bed side walls and require removal of the tailgate 2 for installation. A door (not shown) may be added to the rear side panel 60 to allow a person to enter the removable top standing at least partially upright.

Combined, the panels 30, 60, 90, 120, 150, and 180 add a top where a top previously did not exist or may replace a commercially available top. Therefore, the removable top 1 should preferably attach to the vehicle in a manner similar to a commercially available top. However, the top 1 and/or the vehicle 10 may be modified to ensure a proper fit. For example, older vehicles may have different attachment points than the current production vehicles. Clamps, catches, bores, integral nuts, and/or other components may need to be added to either the panels or the vehicle structural portions. Current tops are attached to vehicles using nuts and bolts at a number of locations along each of the vehicle side panels and additional locations along the rear and front panels.

However, the removable top 1 of the present invention may be attached to a vehicle 10 using other attachment points and/or methods without deviating from the scope of this invention.

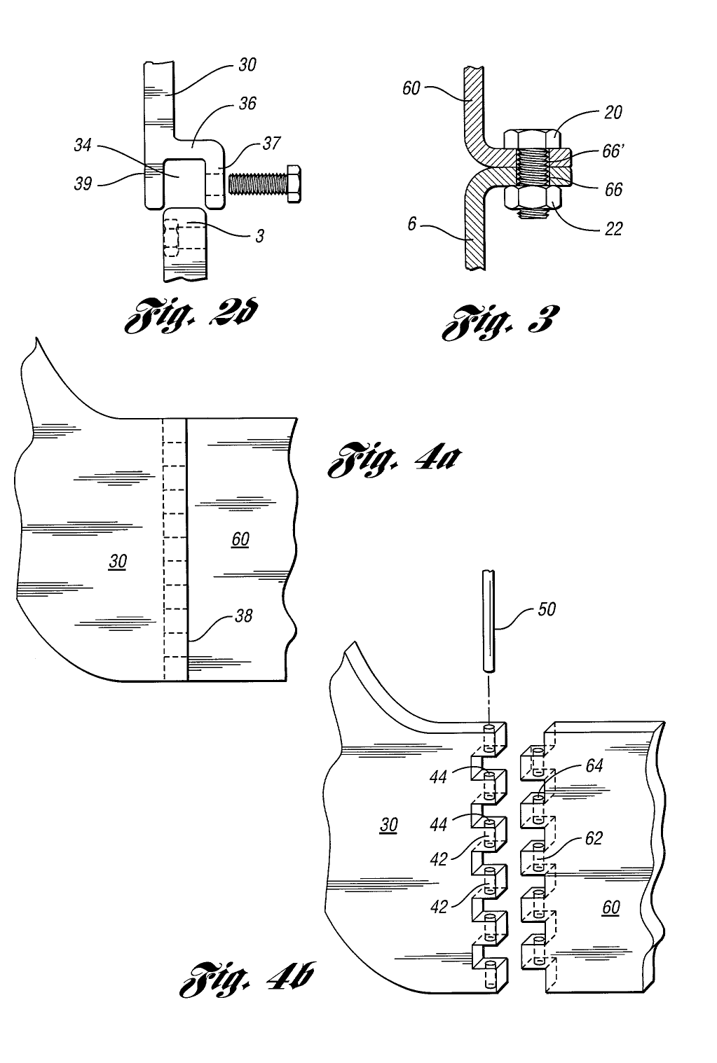

The removable top 1 can be assembled onto a vehicle in several ways. However, the preferred assembly method is to first attach side panel 30 to the vehicle. In one attachment method, as shown in FIG. 2a, first side panel 30 having holes 31′ is placed over first side structural vehicle portion 3 with holes 31 such that holes 31 and 31′ are aligned. Reaching inside the vehicle, a screw or bolt 20 is placed through holes 31 and 31′ and tightened using nut 22. The first side panel 30 is now self supporting. The bottom edge 32 of the first side panel 30 can either be a radius, as shown in FIG. 2a, or it can extend further downward, as shown in FIG. 2c. By extending the edge 32 even farther, it can be used to further stabilize the side panel while it is self supporting. The nut 22 can also be made integral to the vehicle body to simplify assembly of the panel to the vehicle. Conversely, the nut 22 may be made integral to the panel and the bolt 20 may be inserted from below. Alternatively, a cotter pin (not shown) could simply be inserted through a bore in a pin (not shown) to secure the panels.

The assembly process can be simplified by using an ergonomically designed, hand-turnable bolt 20 having a retainer washer 21 so that the bolt 20 is semi-permanently attached to the panel 30 as shown in FIG. 2b.

In FIG. 2c, an alternative method of assembling the side panel 30 to side vehicle structural portion 3, is shown using a clamp 25. Clamp 25 can be a mechanical toggle requiring a catch 26, as shown, or any other clamping devices. A “catch” or hook may need to be added to the structural portions of the vehicle for full and proper use of the clamp 25. One skilled in the art could devise a clamp or panel structure such that a catch is not required. Alternatively, the clamp 25 can be placed on the vehicle structural portion to catch the panel.

A third method of attaching the side panel 30 to side vehicle structural portion 3 is shown in FIG. 2d. Side panel 30 has proximate its bottom edge 39 an inwardly facing flange 36. A flange 37 extends downwardly from the inwardly facing flange 36 forming a channel 34. The dimensions of flanges 36 and 37, and therefore channel 34, are designed such that channel 34 fits over the top of side vehicle structural portion 3. The side panel 30 can be further secured to the side vehicle structural portion 3 using nuts and bolts through either flanges 36 (not shown) or 37 and side vehicle structural portion 3. A nut may be made integral to the side vehicular portion.

Alternatively or supplementally, the panels may be attached to the vehicle using any other suitable methods, such as magnets, electromagnets, hook and loop type fasteners, adhesives, or other methods. The bolt, screw, or pin can also be commonly referred to as a fastening device.

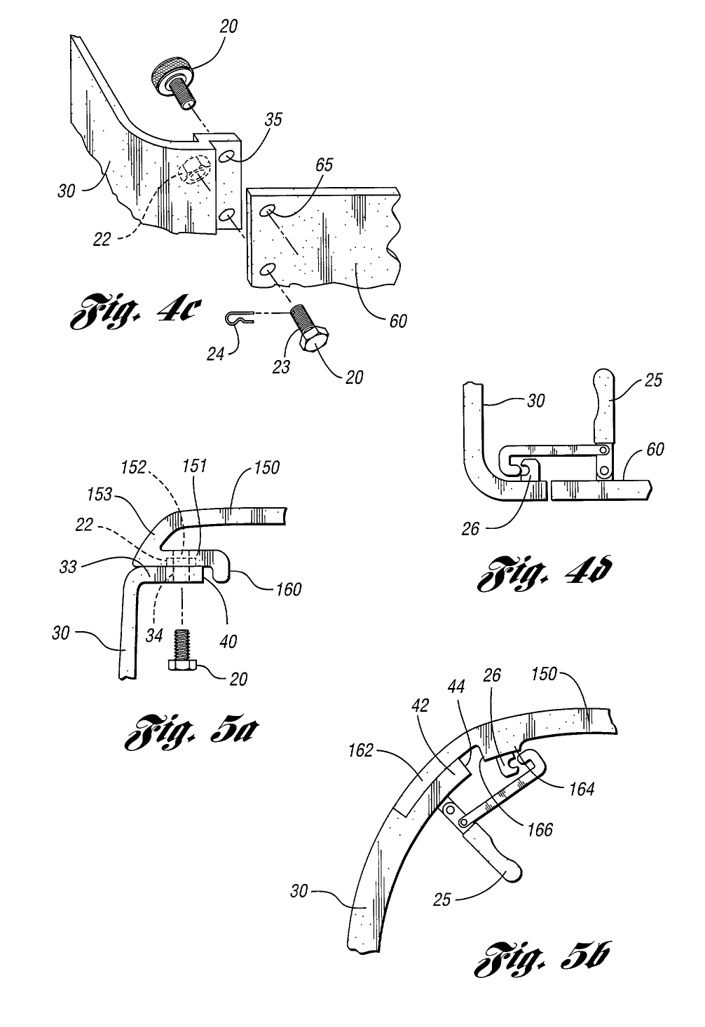

According to one method of assembling the removable top 1, the rear side panel 60 is then attached to rear vehicle structural portion 6. Preferably, rear side panel 60 is connected in any manner previously described for the attachment of panel 30. As shown in FIG. 3, holes 66′ in rear side panel 60 and holes 66 in rear vehicle structural portion 6 are aligned and a bolt 20 is installed therethrough. One or more attachment points may be needed. Rear side panel 60 may have a liftgate 8 that can be opened to make it easier to attach rear side panel 60 to the rear side structural portion 6 of the vehicle. Rear side panel 60 may also be attached using any other method described above.

Next, second side panel 90 is attached to second side structural vehicle portion 9 using any of the methods described above. However, the side panel 90 may be attached to the vehicle before the rear panel 60 is attached.

The front side panel 120 is attached to the front structural vehicle member 12 using, for example, any of the methods discussed above.

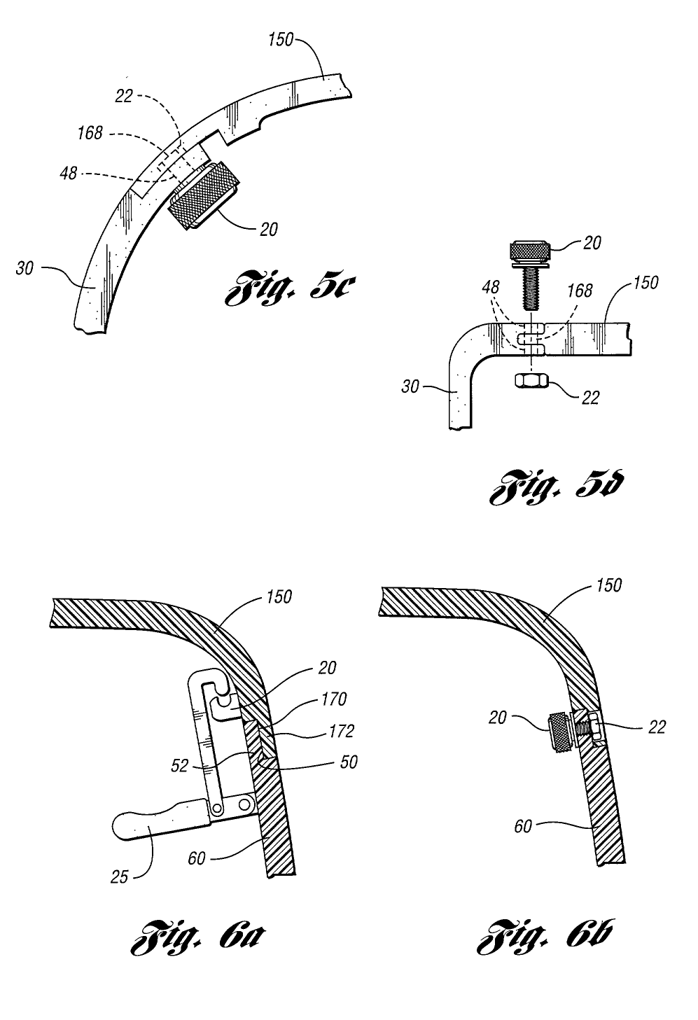

For extra rigidity, rear side panel 60 and/or the front side panel 120 may be attached to side panels 30 and 90. Three different methods of attachment are illustrated in FIGS. 4a (and 4b), 4c, and 4d. As shown in FIGS. 4a and 4b, side panel 30 or 90 can have a corrugated structure having projections 42. A bore 44 extends through each projection 42. Rear side panel 60 may also have a complementary corrugated structure having projections 62 each with bores 64 therein. Side panel 30 or 90 is then matched with rear panel 60. A dowel 50 is then inserted through bores 44 and 64 to secure the side panel 30 or 90 to rear panel 60. As shown in FIG. 4a, flap 38 may extend from either the exterior surface of side panel 30 or 90 or the exterior surface of rear panel 60 to cover the corrugated structure and make it appear as if it is a straight line. Additionally, or in the alternative, a flap may extend from the interior surface of either side panel 30 or 90 or rear panel 60 to cover the corrugated appearance from the interior.

FIG. 4c illustrates another method of attaching the side panels 30 and 90 to the rear side panel 60 or front side panel 120. In this figure, rear panel 60 and side panel 30 contain horizontal bores therein, 65 and 35 respectively, which are in alignment when the panels are properly assembled. A bolt 20 is inserted through the holes from either direction and secured with a nut 22. A securing means, such as a pin 24, may be inserted through bore 23 on the bolt 20 to prevent tampering. The pin 24 may be inserted from inside the vehicle to secure the bolt 20 without the need for a nut to further simplify the assembly process. Either panel may be contoured to provide a more flush surface. Further, the bolt 20 or the nut 22 may be affixed or molded integrally to either panel to make assembly easier. Also, either bore 65 or 35 may be simply threaded so that no additional nut is needed. As previously described, the bolt 20 may be an ergonomically designed, hand-turnable bolt.

FIG. 4d shows another method of attaching side panel 30 to the rear side panel 60 or front side panel 120 using a clamp 25 and catch 26 as described above.

The preferred embodiment of the removable top 1 comprises two top panels 150 and 180. The suggested next assembly step for this preferred embodiment involves attaching the rear top panel 150 to the side and rear panels 30, 60 and 90.

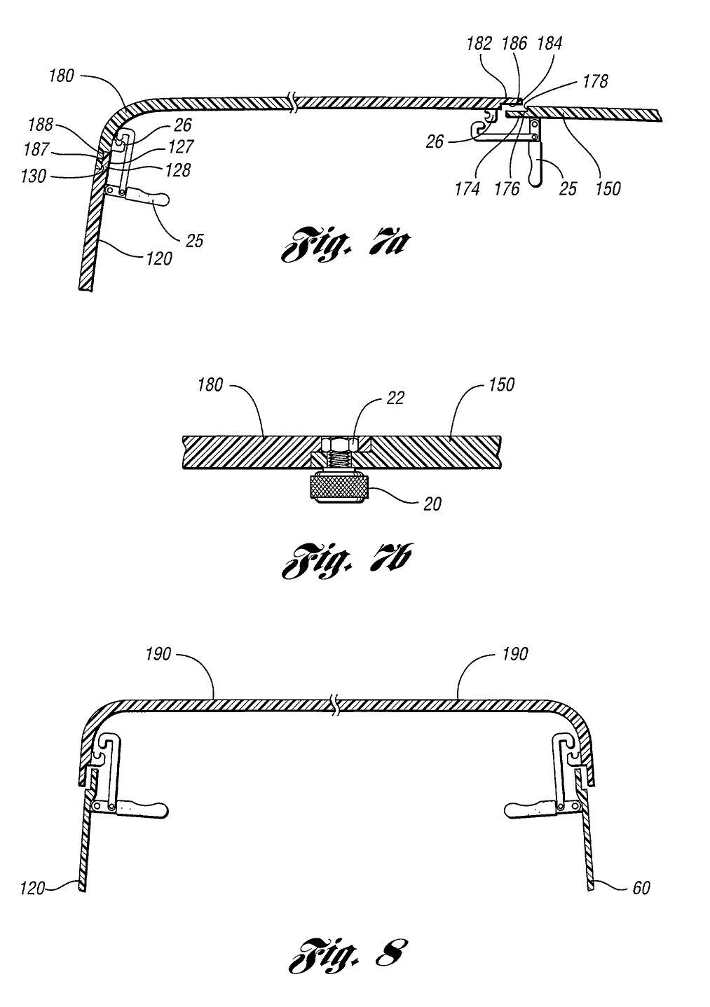

Rear top panel 150 can be attached to the side panels by a variety of methods. Four different methods are illustrated in FIGS. 5a-5d, though the invention is not limited to the methods shown.

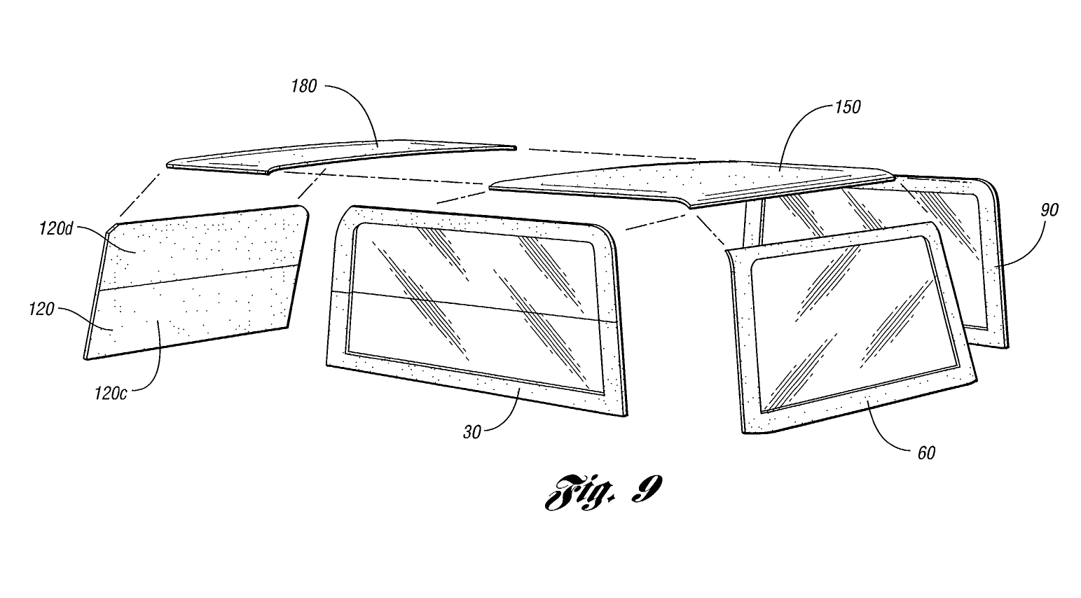

The first method is shown in FIG. 5a. Side panel 30 comprises a flat portion 33 extending towards the interior of the vehicle. The flat portion 33 is shown as horizontal, though it may be angled either up or down. Bore 34 extends through flat portion 33. Rear top panel 150 comprises a downward extending portion 153 and an inward facing flat portion 151. The angle of the inward facing flat portion 151 is designed to match the flat portion 33. Inward facing flat portion 151 has a bore 152 therein which aligns with the bore 34 and causes downward extending portion 153 to align with side panel 30. The top rear panel 150 is then placed on top of the side panels 30 and 90 from the rear of the vehicle and pushed forward until the end of the top rear panel 150 aligns with the rear panel 60 (as shown in FIGS. 6a and 6b). When in proper position, a bolt 20 is pushed through aligned bores 152 and 34 and secured with a nut 22. To make assembly easier, nut 22 can be made integral with inward facing flat portion 151 and bolt 20 can be a hand-turnable bolt semi-permanently attached to the side panel 30. Or, as previously described, bore 152 may simply be threaded to negate any need for an additional part. Further, to help align the panels 30 and 150, the inwardly facing flat portion 151 may have a downstanding flange 160 to abut or otherwise cooperate with the inside edge 40 of flat portion 33. The gap between downstanding flange 160 and inside edge 40 will depend on specific manufacturing and design criterion.

FIG. 5b illustrates using a clamp 25 and catch 26 to attach the components. Side panel 30 comprises a top portion 42 that may taper slightly and end with surface 44. Top rear panel 150 comprises an end portion 162 that may taper slightly and a stopping block 164 having an outside surface 166. FIG. 5b illustrates the union of the two panels taking place at approximately the corner created by the two panels, though the union may take place on the removable top 1 or even on the top portion of the removable top 1. End portion 162 overlaps top portion 42 and therefore, the portions 162 and 42 may be tapered and/or stepped (as shown) to create a better refined appearance. The outside facing surface 166 may co-operate with surface 44 to ease assembly illustrated in FIG. 5b. Clamp 25 and catch 26 may be used to secure side panel 30 to the top rear panel 150.

FIG. 5c illustrates another attachment method wherein the side and top rear panels 30 and 150 are similar to those described in FIG. 5b except that at least one nut 22 and bolt 20 is used to attach the panels together through bores 48 and 168 in the side and top rear panels respectively. The nuts and bolts may be inserted from either side and securing means may also be used. Preferably, the nut 22 is integral to top rear panel 150 and the bolt 20 is semi-permanently attached to side panel 30.

Lastly, a tongue and groove assembly method may be used as shown in FIG. 5d. In this illustration, the tongue is shown on the top rear panel 150 and the groove is shown on the side panel 30 though it is possible to reverse the location of the tongue and grove. The panels may be attached using either a dowel (not shown) or a nut 22 and bolt 20 through bores 168 and 48 of the top rear panel 150 and side panel 30 respectively. Securing means may also be used.

Preferably, top rear panel 150 is attached to rear side panel 60. FIG. 6a shows one example of how the top rear panel 150 attaches to the rear panel 60. Clamp 25 and catch 26 may be used to clamp the two panels 60 and 150 together. However, it is preferred to have co-operating step 172 in top panel 150, with forward facing surface 170, and co-operating step 52 in rear side panel 60, with rearward facing surface 50, in top rear panel 150 and rear panel 60, respectively, to add extra support and assist with alignment. In operation, the top rear panel 150 is placed on top of side panels 30 and 90 and slid forward until surface 170 abuts surface 50. Of course, the top rear panel 150 and the rear panel 60 may be attached using other methods. For example, an integrally molded nut 22 and a hand-turnable, semi-permanently attached bolt 20 may be used as shown in FIG. 6b.

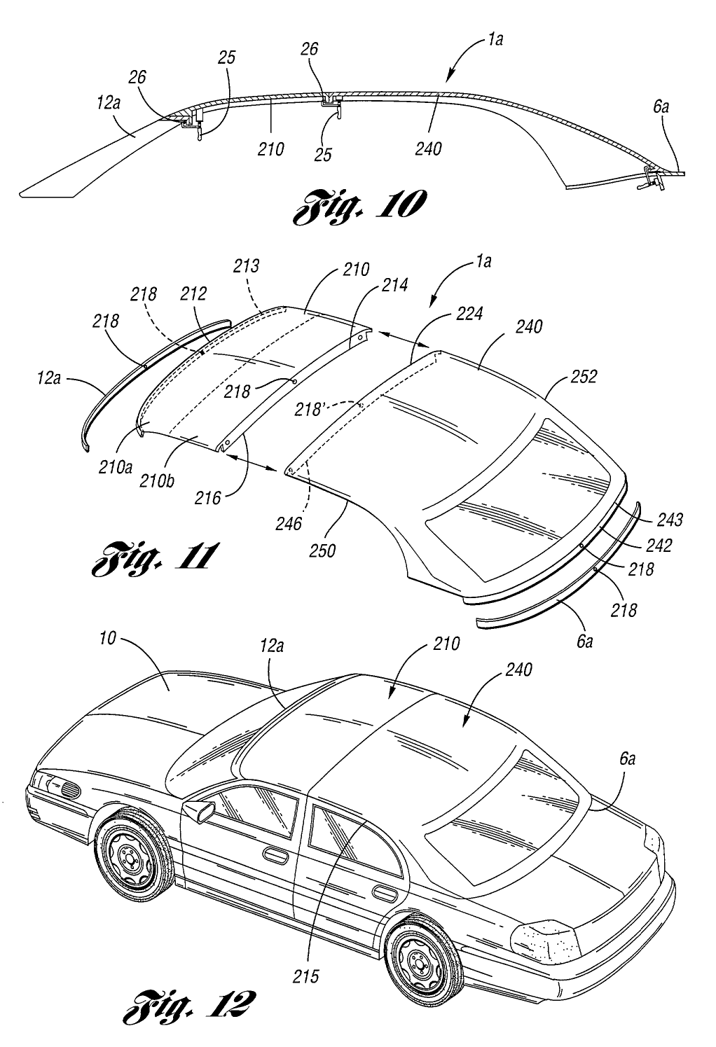

Referring now to FIG. 7a, the next step in attaching the preferred embodiment is to attach the rear top panel 150 to the top front panel 180.

Preferably, a flange 182 having a rear surface 184 and a bottom surface 186 extends from the rear of top front panel 180. Further, a flange 174 having a top surface 176 and a forward facing surface 178 extends from top rear panel 150.

The top front panel is positioned on the top of the side panels such that the rear surface 184 abuts, or is proximate, the forward facing surface 178 of rear top panel 150 and bottom surface 186 rests on top of top surface 176. The order of placement of the top panels 180, 150, is not critical and thus, the flange and step or clamp may be placed on the other top panel. Of course, one skilled in the art could devise other methods of attaching the top panels together.

Various gaskets and water tight junctions, such as those discussed in U.S. Pat. No. 6,203,100, may be used to prevent water from entering the vehicle.

The front top panel 180 may be attached to the top rear panel 150 using a clamp 22 and catch 26 (as shown in FIG. 7a), or other known means, such as a nut and bolt (as shown in FIG. 7b).

FIG. 7b shows an alternative method of attaching front top panel 180 to rear top panel 150 using an ergonomic, hand-turnable, semi-permanently attached bolt 20 and an integrally molded nut 22.

The next assembly step is depicted in 7a is a method of attaching the front top panel 180 to front side panel 120. Front top panel 180 may have a downstanding flange 188 having a rearward facing surface 187. Front side panel 120 has a corresponding upstanding flange 128 having a forward facing surface 127. The front side panel 120 and the front top panel 180 may be removably secured to each other using a clamp 25 and catch 26 (as shown in FIG. 7a) or other means.

FIG. 8 illustrates the second embodiment of the removable top 1 comprising five panels. In this embodiment, the top panel comprises a single panel 190. Side panels 30, 60, 90, and 120 may remain the same. The top panel 190 may removably attach to the side panels 30, 60, 90, and 120 in any manner discussed above.

Further, the side panels 30 and 90 may themselves comprises multiple panels as shown in FIG. 1. First side panel 30 may comprise a first forward side panel 30a removably attachable to a first rearward side panel 30b. Similarly, second side panel 90 may comprise a second forward side panel 90a removably attachable to a second rearward side panel 90b. For certain applications, it might be advisable to divide the side panels into two panels removably attachable to each other. The panels 30, 60, 90, and 120 may be subdivided into 2, 3 or more panels depending on the particular application. The panels may removably attachable to each other by any manner discussed above such as clamps (as shown, for example in FIGS. 7a); nuts and bolts (as shown, for example in FIGS. 7b); or a dowel pin (as shown in FIG. 4b).

Additionally, the panels 30, 60, 90, and 120 may be subdivided to make shorter panels as shown in FIG. 1. Accordingly, the front side panel 120 may comprise a front lower side panel 120c removably attachable to a front upper side panel 120d. Similarly, the other side panels may be divided into upper and lower panels. Further, the side panels could be divided into 3 or more panels depending on the particular application. As discussed above, the side panels may be removably attachable to each other by any manner discussed above such as clamps; nuts and bolts; a dowel pin; or other means.

Another embodiment of the present invention comprising two parts is illustrated in FIGS. 10-12. Specifically, FIG. 10 depicts one method of assembling the 2 and 3 piece removable top 1a. In the two piece design, the removable top 1a is comprised of a top forward panel 210 and a top rearward panel 240. The top panels are removably attachable to each other and to the vehicle. Top forward panel 210 may be removably attached to the front vehicle structural member 12a with at least one clamp 25. Front vehicle structural member 12a is usually the frame for the front windshield. Clamp 25 can be a mechanical toggle requiring a catch 26, as shown, or any other type of clamping device. Additionally, clamp 25 may be used to attach the top rear panel 240 to the rear structural portion 6a of the vehicle. The clamp 25 and catch 26 may be located either inside or outside of the vehicle passenger and storage compartments.

FIG. 11 depicts another method of attaching the top panels in the 2 and 3 piece designs shown. In the 2 piece design, the rear edge 214 of the top forward panel 210 has a downward flange 216. Flange 216 has at least one bore 218 therein. The forward edge 224 of the top rearward panel 240 has a corresponding downward flange 246 with at least one bore 218′ therein which aligns with the bore 218 of the top forward panel 210. The panels may then be assembled using bolts and nuts (not shown). As described above, the panels 210 and 240 may have overlapping flanges having aligning bores therein which are secured using a fastener.

The front edge 212 of forward top panel 210 has a downward flange 213 with at least one bore 218 therein. Vehicle structural member 12a may also have corresponding bores (not shown) that align with the bores 218 in the flange 213. The top forward panel 210 may then be removably attached to the front structural member 12a using fasteners. Instead of downstanding flanges, the top forward panel 210 and the front structural member 12a may have overlapping portions, each of the overlapping portions having aligning bores therein. A fastener may then be inserted through the bores to removably secure the panel to the vehicle.

The rear edge 242 of the rear top panel 240 may have a downward flange 243 with bores 218 therein. The corresponding structural portion 6a of the vehicle may also have a corresponding flange (not shown) with bores therein. The bores 218 of the flange 243 and bores 218 in structural portion 6a of the vehicle align and a fastener may be used to removably secure the rear top panel 240 to the vehicle. As before, the panel and the vehicle may have overlapping portions having aligning bores therein.

The bottom side edges of the top panels in both the 2 and 3 piece designs depicted in FIGS. 10 and 11 may contain grooves to correspond to the side windows 215 or frame of the vehicle. There may be more than one side vehicle per vehicle. When the removable top 1a is attached in any of the preferred embodiments and the windows 215 or frame are raised to their full extension, the top edges of the windows 215 or frame may rest in the grooves providing an effective weather and sound barrier.

In certain applications, it may be advisable to split the top forward panel 210 into a front top forward panel 210a and a rear top forward panel 210b as shown in FIG. 11. The front top forward panel 210a and the rear top forward panel 210b may be removable attachable to each other using any of the methods described above such as a fastener through bores in the panels or a clamp.

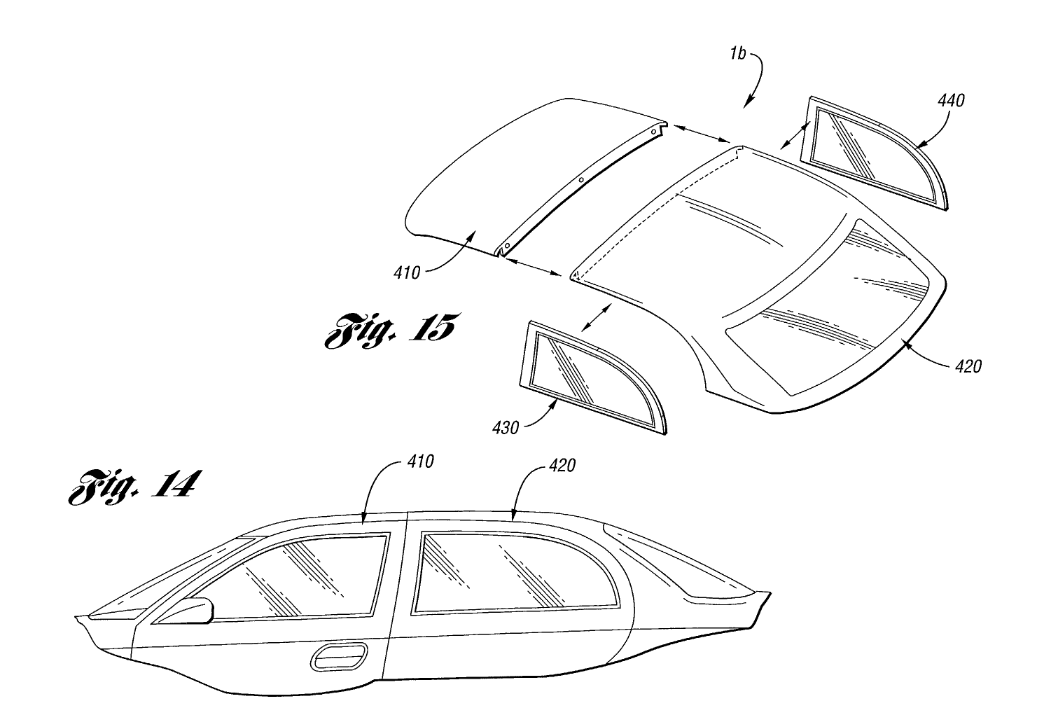

Another embodiment of the removable top 1b having three or four panels is shown in FIGS. 13-15. In the embodiment shown, the removable top 1b is comprised of a single top panel 310 and first and second opposing side panels 340 and 370. The top panel 310 has a front edge 312, a rear edge 314, and first and second edges 316 and 318. The rear edge 314 of the top panel 310 is removably attachable to the corresponding structural portion 6b of the vehicle using, for example, a clamp or a fastener as described above. The front edge 312 of the top panel 310 is removably attachable to the corresponding edge of the vehicle's front structural member 12b using, for example, a clamp or fastener as described above. One skilled in the art could devise alternative methods to attach the removable top 1b to the vehicle. Side panel 340 is removably attachable to top panel 310 at side edge 318 of the top panel 310, and opposite side panel 370 is removably attachable to the opposite side edge 316 of top panel 310 using, for example, a fastener through bores 320 in the flanges as shown in FIG. 13a or a clamp. Bottom edge 342 of side panel 340 and bottom edge 372 of side panel 370 are removably attachable to side structural panels, e.g., 3b of the vehicle.

FIGS. 14 and 15 depict a side view and an exploded view of one 4 piece design according to the present embodiment. The top panel of the invention is comprised of a forward panel 410 and a rearward panel 420. The top is further comprised of corresponding side panels 430 and 440.

In each of the FIGS. 10-15, any method of attaching the panels either to each other or to the vehicle discussed previously may be used.

The multi-panel, removably attachable top 1 described herein combines the strengths, while minimizing the weaknesses, of all types of currently available removably attachable hard tops for vehicles having open compartments. The invention insulates passengers and cargo from the elements, including extreme temperatures. The invention also offers security to the cargo compartments of the vehicle.

Most significantly, the invention is easily removable and equally easily storable. Because the invention is composed of multiple integrated panels, all of which are removably attachable to each other and to structural portions of the vehicle, the entire top (panel by panel) can be removed quickly and easily by one person. Once removed, the panels, being virtually flat and smaller in size than the currently available hard tops, are easily storable in a much smaller area than that required by currently available hard tops, and may be designed to fit within the cargo compartments and/or portions of the passenger compartments of the vehicle. The panels can also be designed to stack on top of each other thereby requiring less storage space. The panels may be essentially flat having minimal curves and edges making stacking easier. The curved edges could be alternated such that the height of the six stacked panels will be essentially the height of the six thicknesses. The length on width of the stack will essentially be the length and width of the largest panel. By subdividing the panels, storage becomes even easier.

The removably attachable top 1, 1a, and 1b described herein, composed of integrated panels removably attachable to each other and to structural portions of the vehicle, is designed to maximize all advantages and minimize all disadvantages of currently available hard tops by creating a rigid, secure, and weather-tight enclosure for the cargo compartments of the vehicle and offer ease of removal and storage not possible with currently available removably attachable tops.

Lights or other electrical devices, such as window defrosters and windshield wipers, may be attached to the interior of the removable top. Currently, a wire that hangs from the light is plugged into a circuit wired to the vehicle. To simplify and improve the appearance of the removable top, electrical connections can be provided in the removable panels. For instance, an electrical connection to an electrical circuit may be provided on one of the side structural portions of the vehicle. The electrical connection may be a vehicle electrical plug or merely vehicle electrical contacts. The side panel proximate the electrical connection may have a corresponding side panel electrical plug to plug into the vehicle electrical plug or corresponding panel electrical contacts that communicate with vehicle electrical contacts. A panel electrical wire may be molded in the side panel. The light or other electrical device connects to the panel electrical wire.

The panel electrical wire can go to a top edge of the side panel where it connects to a electrical plug or electrical contacts. When another panel having an electrical plug is attached to the side panel, the electrical plugs may be connected. Alternatively, both panels may have electrical contacts that electrically communicate with each other to further conduct electricity. The electrical device may then be attached to the other panel.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is: We claim:

1. A removable top for a vehicle having an open compartment, the vehicle having a first side structural portion, a second side structural portion, at least one rear side structural portion, and a front structural portion, the removable top comprising:
a first side panel having an upper edge, a lower edge, a front edge, and a rear edge;
a rear side panel having an upper edge, a lower edge, a first side edge, and a second side edge;
a second side panel having an upper edge, a lower edge, a front edge, and a rear edge;
a front side panel having an upper edge, a lower edge, a first side edge, and a second side edge; and
a top panel having a front edge, a rear edge, a first side edge, and a second side edge.

2. The removable top of claim 1 wherein the top panel comprises a top forward panel and a top rearward panel, the top forward panel being removable attachable to the top rearward panel.

3. The removable top of claim 1 wherein the first side panel comprises a first forward panel and a first rearward panel, the first forward panel being removably attachable to the first rearward panel.

4. The removable top of claim 3 wherein the second side panel comprises a second forward panel and a second rearward panel, the second forward panel being removably attachable to the second rearward panel.

5. The removable top of claim 1 wherein the first side panel is removably attachable to the first side structural portion; the rear side panel is removably attachable to the rear side structural portion; the front side panel is removably attachable to the front side structural portion, and the second panel is removably attachable to the second side structural portion.

6. The removable top of claim 1 wherein the lower edge of the first side panel is removably attachable to the first side structural portion; the lower edge of the rear side panel is removably attachable to the rear side structural portion; the lower edge of the front side panel is removably attachable to the front side structural portion, and the lower edge of the second panel is removably attachable to the second side structural portion.

7. The removable top of claim 1 wherein the top panel is removably attachable to the rear side panel, the top panel is removably attachable to the first and second side panels, and the top panel is removably attachable to the front side panel.

8. The removable top of claim 1 wherein the rear edge of the top panel is removably attachable to the top edge of the rear side panel, the side edges of the top panel are removably attachable to the top edges of the first and second side panels, and the front edge of the top panel is removably attachable to the top edge of the front side panel.

9. The removable top of claim 1 wherein the rear edge of the first side panel is removably attachable to the corresponding first side edge of the rear side panel and the rear edge of the second side panel is removably attachable to the corresponding second side edge of the rear side panel.

10. The removable top of claim 1 wherein the side panels have bores therein to removably attach the side panels to the vehicle.

11. The removable top of claim 1 wherein the bottom edges of the side panels have bores therein to removably attach the side panels to corresponding structural portions of the vehicle.

12. The removable top of claim 1 wherein the rear side panel has at least one bore therein to removably attach the rear side panel to the vehicle.

13. The removable top of claim 9 wherein the rear edges of the side panels have a corrugated structure having projections with bores extending therethrough, the side edges of the rear side panel have a complementary corrugated structure having projections with bores extending therethrough, and wherein the removable top further includes a dowel that can be inserted through the bores to secure the side panels to the rear panel.

14. The removable top of claim 1 further comprising clamps for removably attaching the first and second side panels to the rear side panel

15. The removable top of claim 1 wherein the first and second side panels have bores therein, the rear side panel has bores therein which align with the bores in the first and second side panels, and the removable top further comprises a fastening device for inserting through the bores to removably secure the panels together.

16. The removable top of claim 1 further comprising clamps for attaching the top panel to the first and second side panels.

17. The removable top of claim 1 wherein the top panel has bores therein, the first and second side panels have bores therein which align with the bores in the top panel, and the removable top further comprises a fastening device for inserting through the bores to removably secure the panels together.

18. The removable top of claim 2 wherein the top rearward panel and top forward panel have a top and bottom surfaces, and one of the top rearward panel or top forward panel comprises an extending lip that extends towards the other of the top rearward panel or top forward panel, and the other of the top rearward panel or top forward panel rests on top of the extending lip.

19. The removable top of claim 2 further comprising clamps for removably attaching the top forward panel to the top rearward panel.

20. The removable top of claim 1 wherein the panels are configured to be stackable.

21. The removable top of claim 15 wherein the fastening device comprises a throughbore and the removable top further comprises a pin for insertion into the throughbore of the fastening device after it is inserted through the bores for securing the fastening device.

22. The removable top of claim 14 wherein the side edges of the top panel are removably attachable to the top edges of the side panels.

23. The removable top of claim 2 further comprising a clamp for removably attaching the top forward panel to the top rearward panel.

24. The removable top of claim 2 wherein the top forward panel has a forward end and a rearward end, the top forward panel further comprising a downstanding flange at its rearward end;
wherein the top rearward panel has a forward end and a rearward end, the top rearward panel further comprising a downstanding flange at its forward end; and
wherein the downstanding flange of the top forward panel is proximate to the downstanding flange of the top rearward panel.

25. The removable top of claim 24 wherein the downstanding flange of the top forward panel comprises at least one bore, the downstanding flange of the top rearward panel comprises at least one bore that aligns with the at least one bore of the downstanding flange of the top forward panel.

26. The removable top of claim 25 wherein the removable top further comprises at least one fastening device to secure the top forward panel to the top rearward panel, the fastening device inserted through the bores in the downstanding flanges.

27. The removable top of claim 2 wherein the top forward panel has at least one bore, and the top rearward panel has at least one bore which aligns with the bore in the top forward panel, and the removable top further comprises a fastening device to secure the top forward panel to the top rearward panel through the bores therein.

28. The removable top of claim 3 further comprising a clamp for removably attaching the first forward panel to the first rearward panel.

29. The removable top of claim 3 wherein first forward panel has a forward end and a rearward end, the first side panel further comprising an inwardly facing flange at its rearward end;
wherein the first rearward panel has a forward end and a rearward end, the first rearward panel further comprising an inwardly facing flange at its forward end; and
wherein the inwardly facing flange of the first forward panel is proximate to the inwardly facing flange of the first rearward panel.

30. The removable top of claim 29 wherein the inwardly facing flange of the first forward panel comprises at least one bore, the inwardly facing flange of the first rearward panel comprises at least one bore that aligns with the at least one bore of the inwardly facing flange of the first forward panel.

31. The removable top of claim 30 wherein the removable top further comprises:
at least one fastening device to secure the first forward panel to the first rearward panel, the fastening device for inserting through the bores in the inwardly facing flanges.

32. The removable top of claim 3 wherein the first forward panel has at least one bore,
the first rearward panel has at least one bore which aligns with the bore in the first forward panel, and
the removable top further comprises a fastening device to secure the first forward panel to the first rearward panel through the bores therein.

33. The removable top of claim 1 further comprising:
means for removably attaching the first side panel to the front and rear side panels and to the top panel;
means for removably attaching the second side panel to the front and rear side panels and the top panel;
means for removably attaching the front side panel to the top panel; and
means for removably attaching the rear side panel to the top panel.

34. The removable top of claim 1 wherein the panels are substantially solid.

35. A sectional and removable top for an automotive vehicle comprising at least five separate removably attachable panels including a first side panel, a second side panel opposite the first side panel, a rear side panel, a front side panel, and a top panel, wherein the first and second side panels are removably attachable to the top panel, the front panel, and the rear side panel and wherein the rear side panel is removably attachable to top panel.

36. The top of claim 35 wherein the top panel comprises a top forward panel and a top rearward panel, the top forward panel being removably attachable to the top rearward panel.

37. The removable top of claim 35 further comprising:
means for removably attaching the first side panel to the front and rear side panels and to the top panel;
means for removably attaching the second side panel to the front and rear side panels and the top panel;
means for removably attaching the front side panel to the top panel; and
means for removably attaching the rear side panel to the top panel.

38. The removable top of claim 35 wherein the panels are substantially solid.

39. The top of claim 37 wherein each of the first and second side panels are comprised of one forward panel and one rearward panel and wherein the first forward and first rearward panels are removable attachable to each other and the second forward and second rearward panels are removable attachable to each other.

40. The top of claim 37 wherein the panels are stackable .

41. A vehicle with a removable top:
a vehicle having front, rear, first, and second side structural portions;
a removable top having at least a front panel, a rear panel, a first side panel, and a second side panel, the first side panel being removable attachable to the first structural portion, the second side panel being removable attachable to the second structural portion, the front side panel being removable attachable to the front structural portion, and the rear side panel being removable attachable to the rear structural portion;
a top panel having a front side, a rear side, a first side, and a second side; and
wherein the first side of the top panel is removably attachable to the first side panel, the second side of the top panel is removably attachable to the second side panel, front side of the top panel is removably attachable to the front side panel, and the rear side of the top panel is removably attachable to the rear side panel.

42. The vehicle of claim 41 wherein the first side panel is removably attachable to the front side panel and the rear side panel and
the second side panel is removably attachable to the front side panel and the rear side panel.

43. A removable top for a vehicle having an open compartment, the vehicle having a front structural portion and a rear structural portion, the removable top comprising:
a rear panel having a lower edge and an upper edge;
a front panel having a forward edge and a rearward edge;
wherein the upper edge of the rear panel is removably attachable to the rearward edge of the front panel;
wherein the lower edge of the rear panel is removably attachable to the rear structural portion; and
wherein the forward edge of the front panel is removably attachable to the front structural portion.

44. The removable top of claim 43 wherein the front panel is removably secured to the front structural member with a clamp.

45. The removable top of claim 43 wherein the rear panel is removably secured to the rear structural portion with a clamp.

46. The removable top of claim 43 further comprising a clamp for removably attaching the front panel to the rear panel.

47. The removable top of claim 43 wherein the front panel comprises at least one bore, the rear panel comprises at least one bore which aligns with the bore in the front panel, and the removable top further comprises a fastening device that extends through the bores to removably attach the front panel to the rear panel.

48. The removable top of claim 47 wherein the front panel has a forward and a rearward edge, the forward panel further comprising a downstanding flange at the rearward edge and wherein the at least one bore of the forward panel is in the downstanding flange;
wherein the rear panel has a forward and a rearward edge, the rear panel further comprising a downstanding flange at the forward edge and wherein the at least one bore of the rear panel is in the downstanding flange; and
wherein the downstanding flange of the front panel is proximate to the downstanding flange of the rear panel.

49. The removable top of claim 43 wherein the panels are configured to be stackable.

50. The removable top of claim 43 further comprising:
means for removably attaching the rear panel to the rear structural pportion; and
means for removably attaching the front panel to the front structural portion.

51. The removable top of claim 43 wherein the panels are substantially solid.

52. A removable top for a vehicle having a front structural portion and a rear structural portion, the removable top comprising:
a top panel having a forward edge, a rearward edge, and first and second side edges;
a first side panel having a lower portion and an upper portion;
a second side panel having a lower portion and an upper portion;
wherein the forward edge of the top panel is removably attachable to the front structural portion;
wherein the rearward edge of the top panel is removably attachable to the rear structural portion;
wherein the upper portion of the first side panel is removably attachable to the first edge of the top panel; and
wherein the upper portion of the second side panel is removably attachable to the second edge of the side panel.

53. The removable top of claim 52 further comprising at least one clamp for removably securing the top panel to the front structural portion.

54. The removable top of claim 52 wherein the top panel is removably secured to the rear structural member using at least one clamp.

55. The removable top of claim 52 wherein the top panel comprises a forward and a rearward panel, the forward panel being removably attachable to the rearward panel.

56. The removable top of claim 55 wherein the forward panel comprises at least one bore,
the rearward panel comprises at least one bore which aligns with the bore in the forward panel, and
the removable top further comprises a fastening device that extends through the bores in the forward and rearward panels to removably attach the forward panel to the rearward panel.

57. The removable top of claim 56 wherein the forward panel has a forward and a rearward edge, the forward panel further comprising a downstanding flange at the rearward edge and wherein the at least one bore of the forward panel is in the downstanding flange;
wherein the rearward panel has a forward and a rearward edge, the rearward panel further comprising a downstanding flange at the forward edge and wherein the at least one bore of the rearward panel is in the downstanding flange; and
wherein the downstanding flange of the forward panel is proximate to the downstanding flange of the rearward panel.

58. The removable top of claim 55 further comprising a clamp for removably attaching the front panel to the rear panel.

59. The removable top of claim 52 further comprising a clamp for removably attaching the upper portions of the first and second side panels to the first and second edges of the top panel.

60. The removable top of claim 52 wherein the first and second side panels each comprise at least one bore,
the top panel comprises at least one bore proximate each of the first and second edges which align with the bores in the first and second panels, and
the removable top further comprises a fastening device that extends through the bores to removably attach the first and second panels to the top panel.

61. The removable top of claim 60 wherein the first and second side panels further comprise flanges proximate the upper portions and wherein the bores of the first and second side panels are in the flanges;
wherein the top panel comprises a flange proximate the first and second side edges and wherein the bores of the top panel are in the flange; and
wherein the flanges of the top panel is proximate to the flanges of the first and second side panels.

62. The removable top of claim 52 wherein the panels are configured to be stackable.
